(19) United States
(12) Patent Application Publication
(10) Pub. No.: US 2010/0201577 A1
(43) Pub. Date: Aug. 12, 2010

(54) CHIP ANTENNA

(76) Inventor: SIN-MIN CHANG, Sinjhuang City (TW)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/368,310

(22) Filed: Feb. 10, 2009

(51) Int. Cl. H01Q 1/38

(52) U.S. Cl. 343/700 MS

(57) ABSTRACT

A chip antenna includes a main body having a first surface and a second surface; a microstrip structure disposed on the first surface and the second surface of the main body; and at least one metal piece which is disposed in the main body and located between the first surface and the second surface, the metal piece is electrically connected with the microstrip structure. Since the area of the metal piece is almost equal to that of the first surface or the second surface of the main body, therefore the metal piece can increase the radiation area of the chip antenna greatly so that the chip antenna have greater bandwidth and better electrical characteristics.

### BACKGROUND OF THE INVENTION

1. Field of the Invention

The present invention relates to a chip antenna, and more specifically to a chip antenna with a metal piece.

2. Description of Related Art

With the rapid development of wireless communication industry, most of the electronic products (for example, mobile phones, personal digital assistants, notebook computers, sensing equipments, etc.) transmit signals via wireless communication. Antennas disposed on electronic products act as one primary type of equipment for transmitting and receiving signals in wireless communication. Therefore the popularity and needs for antennas are constantly increasing.

For reducing manufacture costs of antennas and meeting design requirements that the electronic products must be smaller, lighter, and thinner, most of the electronic wireless communication products replace conventional antennas that has large volume (for example, rod antenna) with chip antennas with smaller volume.

Common chip antennas have a generally rectangular board shape and are generally made of ceramic materials. The common chip antennas commonly have surrounding micro strips as radiators, and furthermore transmit or receive wireless signals via the micro strips.

Chip antennas have the advantage of small volume; however, small volume also limits the length of the micro strips, so that the radiation areas of chip antennas are obviously smaller than those of conventional antennas. Therefore bandwidth of chip antennas is limited. To overcome the shortcoming, some scholars and manufacturers have made some suggestions, for example, changing surrounding modes of micro strips, to ensure that more loops of micro strips can be disposed on chip antennas. Another example, to extend one portion of a micro strip out of the antenna can increase the total length of the micro strip and the bandwidth of the antenna.

However, the above methods are all limited in increasing the length of micro strips and the radiation areas of chip antennas, so they are limited in improving the bandwidth of micro strips. Hence, the inventors of the present invention believe that the shortcomings described above are able to be improved and finally suggest the present invention which is of a reasonable design and is an effective improvement based on deep research and thought.

### SUMMARY OF THE INVENTION

A main object of the present invention is to provide a chip antenna which can increase the area for transmitting and receiving wireless signals based on a metal piece, so that the bandwidth of the chip antenna can be increased.

To achieving the above-mentioned object, a chip antenna in accordance with the present invention is provided. The chip antenna includes a main body having a first surface and a second surface; a microstrip structure disposed on the first surface and the second surface of the main body; and at least one metal piece disposed in the main body and located between the first surface and the second surface, the metal piece electrically connected with the microstrip structure.

The efficacy of the present invention is as follows: the area of the metal piece is almost equal to that of the first surface or the second surface of the main body, therefore the metal piece can increase the radiation area of the chip antenna greatly so that the chip antenna have greater bandwidth and better electrical characteristics.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1 is a perspective view of a chip antenna of the present invention;

FIG. 2 is another perspective view of the chip antenna of the present invention;

FIG. 3 is an exploded perspective view of the chip antenna of the present invention;

FIG. 4 is a top view of the chip antenna of the present invention;

FIG. 5 is a schematic view of the chip antenna of the present invention disposed on a second circuit board;

FIG. 6 is another schematic view of the chip antenna of the present invention disposed on the second circuit board;

FIG. 7 is a perspective view of a second embodiment of the chip antenna of the present invention; and

FIG. 8 is an exploded perspective view of the second embodiment of the chip antenna of the present invention.

### DETAILED DESCRIPTION OF PREFERRED EMBODIMENTS

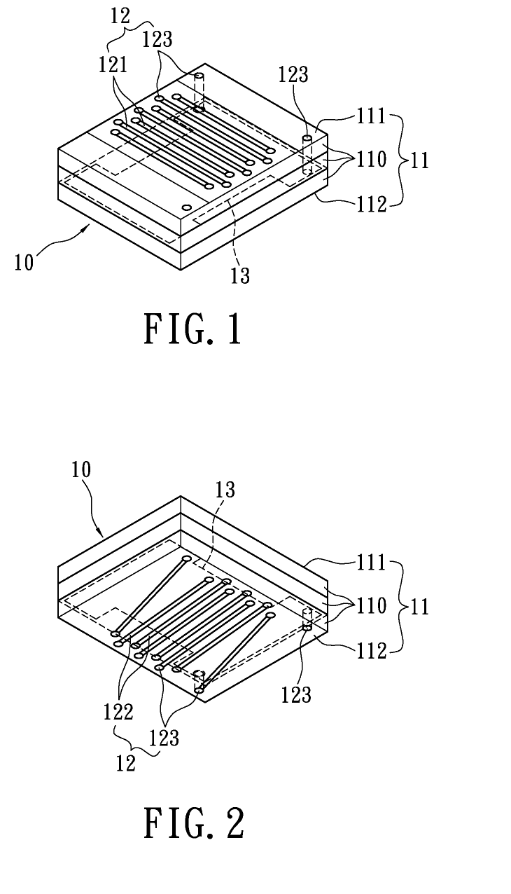

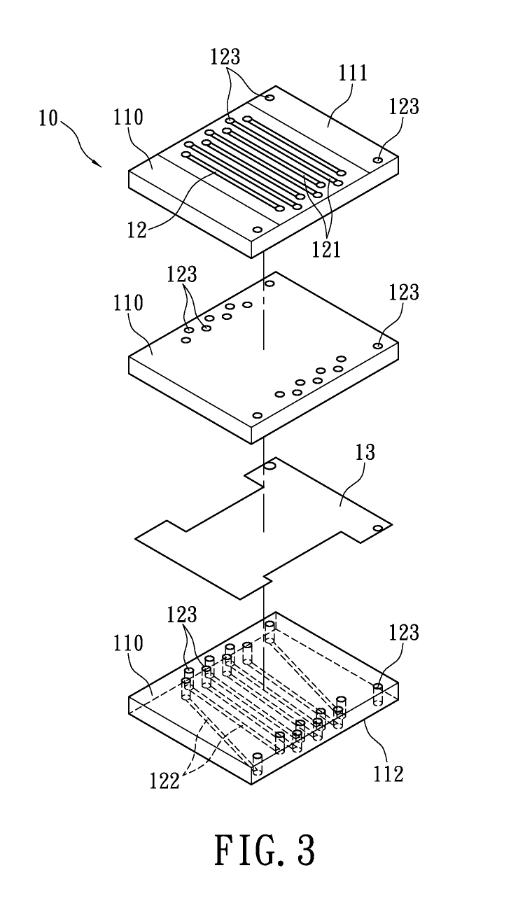

Please refer to FIGS. 1-3 illustrating a chip antenna 10 according to the present invention. The chip antenna 10 includes a main body 11, a microstrip structure 12, and a metal piece 13.

The main body 11 is formed by overlapping three first circuit boards 110. The main body 11 has a length of 5.4 mm, a width of 4.5 mm, and a thickness of 1.6 mm, wherein the two upper first circuit boards 110 have a thickness of 0.4 mm, and the lowest first circuit board 110 has a thickness of 0.8 mm. The material of the first circuit boards 110 may be Flame Retardant 4 (FR-4) and so on.

For the following description, the upper surface of the main body 11 is defined as a first surface 111 and the lower surface thereof is defined as a second surface 112. The microstrip structure 12 is disposed on the first surface 111 and the second surface 112. The metal piece 13 is disposed in the main body 11 and clamped between two of the first circuit boards 110. The area of the metal piece 13 is slightly smaller than that of the first surface 111 or the second surface 112. The metal piece 13 and the microstrip structure 12 are electrically connected, which are made of a metal material with high conductivity (for example, copper). The chip antenna 10 of the present invention uses the microstrip structure 12 and the metal piece 13 as radiators to transmit or receive wireless signals.

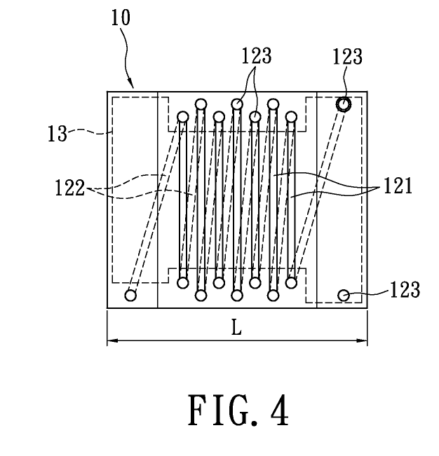

Please refer to FIG. 4, the following is to describe the microstrip structure 12 in detail.

The microstrip structure 12 has a plurality of first micro strips 121, a plurality of second micro strips 122, and a plurality of connecting holes 123. The plurality of first micro strips 121 is fixed on the first surface 111, and the plurality of first micro strips 121 is spaced and is not directly connected with each other. The plurality of first micro strips 121 is perpendicular to the long side L of the main body 11 (the angle is 90 degrees).

The plurality of second micro strips 122 is fixed on the second surface 112, and the plurality of second micro strips 122 is not directly connected with each other. The angle between the plurality of second micro strips 122 and the long side L of the main body 11 is less than 90 degrees. In the top view (FIG. 4), except for the two ends, the other portions of each second micro strip 122 do not overlap with the first micro strips 121.

The plurality of connecting holes 123 is formed on two ends of each first micro strip 121. The diameter of the connecting holes 123 is greater than the linewidth of the micro strips 121. Each connecting hole 123 extends through the main body 11 to one end of the corresponding second micro strip 122. Since the inner walls of the connecting holes 123 are coated with a metal (not shown), the connecting holes 123 can also transmit electric signals so that the plurality of first micro strips 121 and the plurality of second micro strips 122 are electrically connected. When extending through the main body 11, the last (lower right) connecting hole 123 extends through the metal piece 13, so that the metal piece 13 and the connecting hole 123 are contacted with each other and are thereby electrically connected.

The plurality of connecting holes 123 has another feature which is that the two adjacent connecting holes 123 are not located in the same vertical position, as can been seen from the top view (FIG. 4). In other words, the plurality of connecting holes 123 is interlacedly arranged. This feature can ensure that the first micro strips 121 and the second micro strips 122 are arranged closer, thereby increasing the number of the first micro strips 121 and the second micro strips 122.

The features of the microstrip structure 12 have been described above. The following is to describe how the chip antenna 10 of the present invention transmits and receives wireless signals. The chip antenna 10 of the present invention uses the first micro strips 121, the second micro strips 122, and the metal piece 13 as radiators to transmit or receive wireless signals. The foremost (lower left) connecting hole 123 is the feed point of the chip antenna 10. A signal desired to be transmitted may be input into this connecting hole 123 and thereby the signal is transmitted to the foremost first micro strip 121 via the foremost (leftmost) second micro strip 122, then to the second micro strip 122 via the foremost first micro strip 121, and subsequently to the second first micro strip 121 via the second micro strip 122.

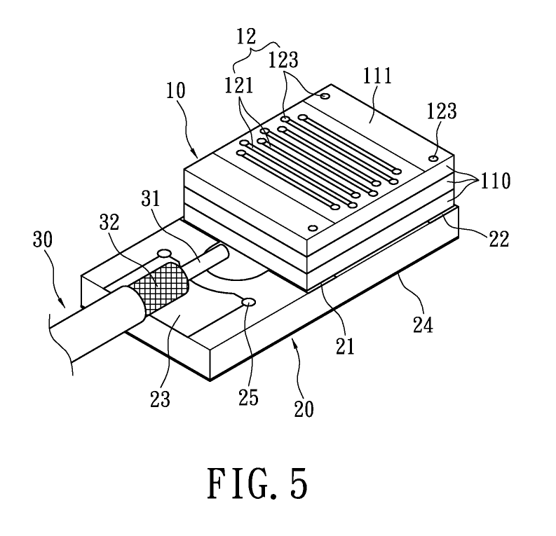

The signal can be transmitted in sequence between the first micro strips 121 and the second micro strips 122. When the signal is transmitted to the last second micro strip 122, the signal is transmitted to the last (lower right) connecting hole 123 via the connecting electrode end 22 of the second circuit board 20 (as shown in FIG. 5) and into the metal piece 13. During transmission, the signal can produce wireless wave. On the other hand, when the plurality of first micro strips 121, the plurality of second micro strips 122, and the metal piece 13 receive the wireless signal, the received signal will be transmitted to the feed point, and then output to other electronic components (not shown). The lower right connecting hole 123 and the upper right connecting hole 123 can also be connected by the second micro strip 122 (not shown), so that the signal can be transmitted into the metal piece 13 without passing through the connecting electrode end 22.

Based on the arrangement of the metal piece 13, the chip antenna 10 of the present invention can increase the radiating area for transmitting and receiving wireless signals greatly, so that the bandwidth of the chip antenna 10 of the present invention can be increased greatly. Furthermore, the present invention can easily adjust the desired bandwidth and field pattern by changing the shape of the metal piece 13. Additionally, the chip antenna 10 of the present invention is a circular-polarized antenna which can produce an omni-direction field pattern.

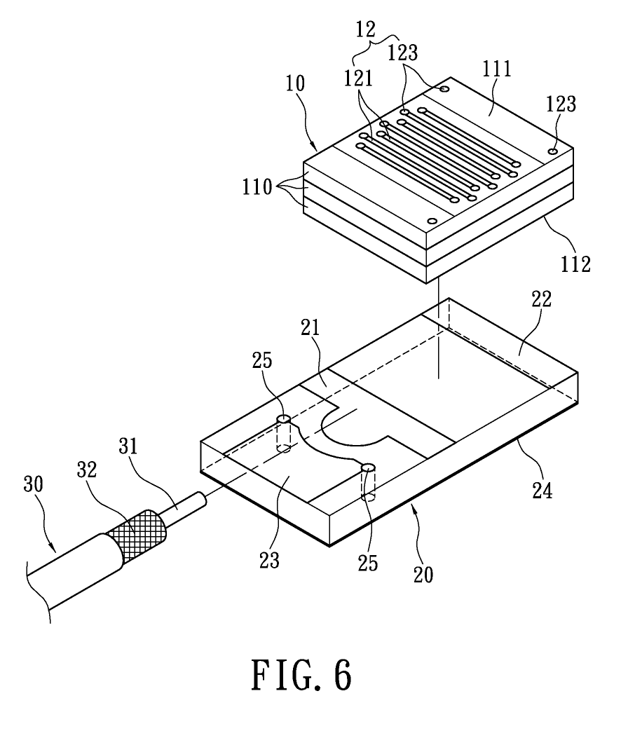

Please refer to FIG. 5 and FIG. 6, the following is to describe how to dispose the chip antenna 10 of the present invention on the second circuit board 20 and how to electrically connect the chip antenna 10 to the second circuit board 20.

The second circuit board 20 has a feeding electrode end 21, a connecting electrode end 22, a grounding electrode end 23, a metal layer 24, and two through-holes 25. The metal of the feeding electrode end 21, the connecting electrode end 22, the grounding electrode end 23, and the metal layer 24 and the metal in the through-holes 25 are all metal materials with high conductivity (for example, copper). The feeding electrode end 21, the connecting electrode end 22, and the grounding electrode end 23 are disposed on the upper surface of the second circuit board 20. Therein the grounding electrode end 23 is located on the leftmost end of the second circuit board 20; the connecting electrode end 22 is located on the rightmost end of the second circuit board 20; and the feeding electrode end 21 is located between the connecting electrode end 22 and the grounding electrode end 23; additionally the feeding electrode end 21, the connecting electrode end 22, and the grounding electrode end 23 are spaced apart and are not directly connected (see FIG. 6 specifically for reference). The metal layer 24 is disposed on the lower surface of the second circuit board 20, and the area of the metal layer 24 is equal to that of the lower surface of the second circuit board 20. The two through-holes 25 are formed in the upper surface of the second circuit board 20, and respectively located in the upper right corner and the lower right corner of the grounding electrode end 23. The two through-holes 25 extend to the metal layer 24 through the second circuit board 20. The inner walls of the through-holes 25 are coated with a layer of metal (not shown), so that the ground electrode end 23 and the metal layer 24 are electrically connected to each other.

When the chip antenna 10 is disposed on the second circuit board 20, the second surface 112 of the chip antenna 10 faces the upper surface of the second circuit board 20, and the foremost (lower left) connecting hole 123 (feed point) is welded to the feeding electrode end 21 and electrically connected with the feeding electrode end 21; additionally the last (lower right) connecting hole 123 and the last second (upper right) connecting hole 123 are welded to the connecting electrode end 22 and electrically connected with the connecting electrode end 22. The connecting electrode end 22 may transmit signals, and the signals are transmitted from the upper right connecting hole 123 to the lower right connecting hole 123. Accordingly, signals may be input into the chip antenna 10 via the feeding electrode end 21 and then be transmitted as wireless wave; or, when the chip antenna 10 receives wireless signals, then the wireless signals may be outputted via the feeding electrode end 21.

The second circuit board 20 is further connected with a coaxial cable 30 which has an inner conductor 31 and an outer conductor 32, the inner conductor 31 located within the outer conductor 32. The inner conductor 31 is connected to and welded on the feeding electrode end 21 and the outer conductor 32 is connected to and welded on the grounding electrode end 23. The coaxial cable 30 may transmit a signal to the feeding electrode end 21; or the coaxial cable 30 may receive a signal from the feeding electrode end 21. The coaxial cable 30 uses the ground electrode end 23 and the metal layer 24 as grounding portions. Since the metal layer 24 can increase the grounding area greatly, the chip antenna 10 can have improved antenna efficiency.

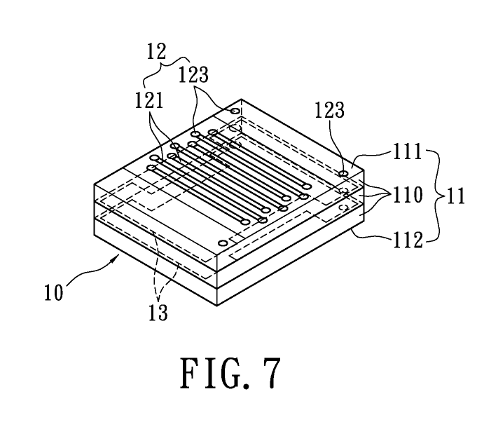

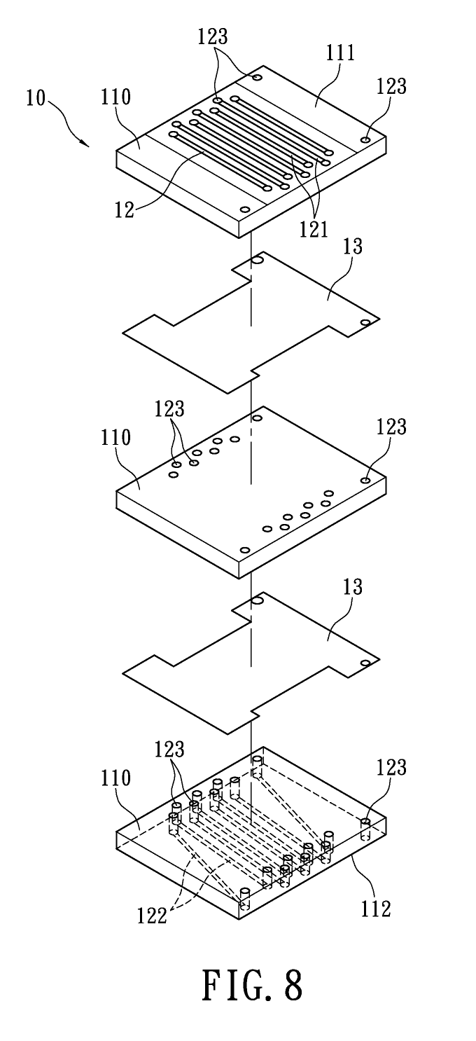

Please refer to FIG. 7 and FIG. 8, the chip antenna 10 of the present invention further has a second embodiment, the difference between the second embodiment and the first embodiment is that two metal pieces 13 are disposed in the main body 11. Each two first circuit boards 110 clamp one metal piece 13 therebetween, and the last (lower right) connecting hole 123 extends through the two metal pieces 13 and is connected with the two metal pieces 13. Thereby by increasing one metal piece 13, the radiating area of the chip antenna can be increased, so that the chip antenna 10 has greater bandwidth and better electrical characteristics.

Additionally, the chip antenna 10 of the present invention also has a third embodiment (not shown), the difference between the third embodiment and the first and the second embodiments is that besides the last connecting hole 123 being electrically connected with the metal pieces 13, the other connecting holes 123 can also be electrically connected with the metal pieces 13, thereby improving the radiation frequency of the chip antenna 10.

Consequently, the chip antenna 10 of the present invention has the advantages as follows:

1. Based on the arrangement of the metal pieces 13, the chip antenna 10 of the present invention can increase the radiating area, so that the chip antenna 10 of the present invention can have greater bandwidth, better electrical characteristics, and improved radiation efficiency;

2. The chip antenna 10 of the present invention has small size, so it is ideal for being applied in electronic products with small volume.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A chip antenna, comprising:
a main body, having a first surface and a second surface;
a microstrip structure, disposed on the first surface and the second surface of the main body; and
at least one metal piece, disposed in the main body and located between the first surface and the second surface, the metal piece electrically connected with the microstrip structure.

2. The chip antenna as claimed in claim 1, wherein the microstrip structure has a plurality of first micro strips, a plurality of second micro strips, and a plurality of connecting holes, and the plurality of first micro strips is fixed on the first surface, the plurality of second micro strips is fixed on the second surface, the plurality of connecting holes connects the first surface and the second surface of the main body, and the plurality of first micro strips is electrically connected with at least one of the plurality of second micro strips via at least one of the plurality of connecting holes.

3. The chip antenna as claimed in claim 2, wherein the at least one of the plurality of connecting holes is electrically connected with the at least one metal piece.

4. The chip antenna as claimed in claim 2, wherein the last connecting hole is electrically connected with the at least one metal piece.

5. The chip antenna as claimed in claim 2, wherein the plurality of connecting holes is interlacedly arranged.

6. The chip antenna as claimed in claim 2, disposed on a circuit board.

7. The chip antenna as claimed in claim 6, wherein the circuit board has a feeding electrode end located on an upper surface thereof, and the microstrip structure is electrically connected with the feeding electrode end.

8. The chip antenna as claimed in claim 7, wherein the foremost connecting hole is electrically connected with the feeding electrode end.

9. The chip antenna as claimed in claim 6, wherein the circuit board has a connecting electrode end located on an upper surface thereof, and the microstrip structure is electrically connected with the feeding electrode end.

10. The chip antenna as claimed in claim 9, wherein the last connecting hole is electrically connected with the connecting electrode end.

11. The chip antenna as claimed in claim 7, wherein the circuit board has a grounding electrode end located on the upper surface thereof, and a coaxial cable is electrically connected with the feeding electrode end and the grounding electrode end of the circuit board.

12. The chip antenna as claimed in claim 11, wherein the circuit board has a metal layer disposed on a lower surface thereof and at least one through-hole connecting the grounding electrode end and the metal layer.
